(19) United States
(12) Patent Application Publication
(10) Pub. No.: US 2025/0187177 A1
(43) Pub. Date: Jun. 12, 2025

(54) GRASPING DEVICE

(71) Applicant: MINEBEA MITSUMI Inc., Nagano (JP)

(72) Inventor: Shotaro MIYAWAKI, Kitasaku-gun (JP)

(21) Appl. No.: 18/846,065

(22) PCT Filed: Mar. 8, 2023
(86) PCT No.: PCT/JP2023/008834

§ 371 Date: Sep. 11, 2024

(30) Foreign Application Priority Data
Mar. 23, 2022 (JP) 2022-046417

(51) Int. Cl. B25J 9/12

(52) U.S. Cl. CPC B25J 9/126

(57) ABSTRACT

A grasping device includes a conversion unit configured to convert rotational driving of a drive shaft into linear motion of a holding part. The conversion unit includes a cam formed with a cam groove recessed from one end surface toward the other end surface, and a bearing inserted into the cam groove. An end surface of the bearing is disposed apart from the one end surface on the other end surface side in an extending direction of the drive shaft.

### TECHNICAL FIELD

The present invention relates to a grasping device.

### BACKGROUND ART

In the related art, there is known an electric gripper having a mechanism configured to convert rotational driving of an output shaft into linear motion of a grasping member (for example, see Patent Document 1). The electric gripper includes a cam having a cam groove and a bearing inserted into the cam groove.

In the grasping device, in order to reduce the size of the device, the bearing is disposed inside the cam groove so that an end surface of the cam and an end surface of the bearing coincide with each other.

### CITATION LIST

### Patent Literature

Patent Document 1: JP 2010-201515 A

### SUMMARY OF INVENTION

### Technical Problem

However, before the assembly of the electric gripper, for example, during transportation of components, the cams may come into contact with each other or another component may come into contact with the cams, and thus a small scratch may be formed on the end surface of the cam formed with the cam groove. When there is a scratch on the cam groove, a bearing may be caught by the scratch when the bearing moves along the cam groove.

An object of the present invention is to provide a grasping device capable of smoothly moving a bearing along a cam groove.

### Solution to Problem

In order to solve the above problems and accomplish the object, a grasping device according to the present invention includes a conversion unit configured to convert rotational driving of a drive shaft into linear motion of a holding part. The conversion unit includes a cam formed with a cam groove recessed from one end surface toward the other end surface, and a bearing inserted into the cam groove. An end surface of the bearing is disposed apart from the one end surface on the other end surface side in an extending direction of the drive shaft.

According to the present invention, the bearing can be smoothly moved along the cam groove.

### BRIEF DESCRIPTION OF DRAWINGS

FIG. 1 is a perspective view of a grasping device according to an embodiment.

FIG. 2 is a cross-sectional view taken along arrow A-A in FIG. 1.

FIG. 3 is a cross-sectional view taken along arrow B-B in FIG. 1.

FIG. 4 is a plan view of a relay plate included in the grasping device according to the embodiment.

FIG. 5 is a perspective view illustrating an interior of the grasping device according to the embodiment.

FIG. 6 is a perspective view illustrating an interior of the grasping device according to the embodiment.

FIG. 7 is a perspective view illustrating a cam attached to a drive shaft in the grasping device according to the embodiment.

FIG. 8 is a perspective view illustrating a cam and a bearing included in the grasping device according to the embodiment.

FIG. 9 is a cross-sectional view of a cam, a bearing, and a shaft included in the grasping device according to the embodiment.

FIG. 10 is a cross-sectional view of a shaft and a block included in the grasping device according to the embodiment.

FIG. 11 is a perspective view illustrating an interior of the grasping device according to the embodiment.

FIG. 12 is a perspective view for explaining attachment of a conversion unit to a motor case in the grasping device according to the embodiment.

FIG. 13 is a diagram for explaining a jig used for assembly of the grasping device according to the embodiment.

FIG. 14 is a perspective view illustrating attachment of a drive unit housing to the conversion unit in the grasping device according to the embodiment.

### DESCRIPTION OF EMBODIMENTS

Hereinafter, an embodiment of a grasping device will be described in detail based on the drawings. Note that the dimensional relationship between elements and the scale of each element in the drawings may differ from reality. The drawings may include parts having mutually different dimensional relationships and scales.

### EMBODIMENT

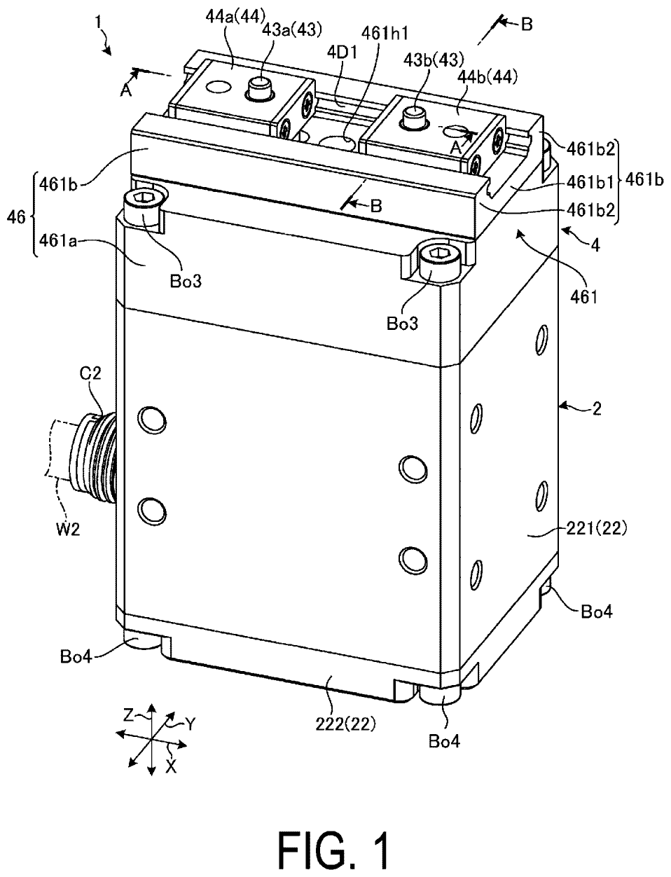

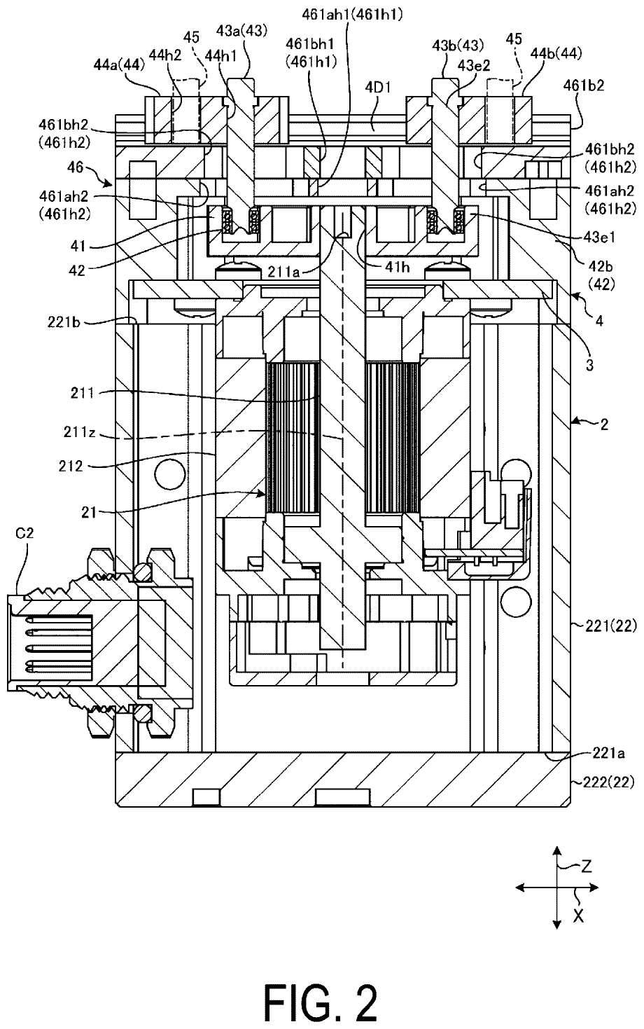

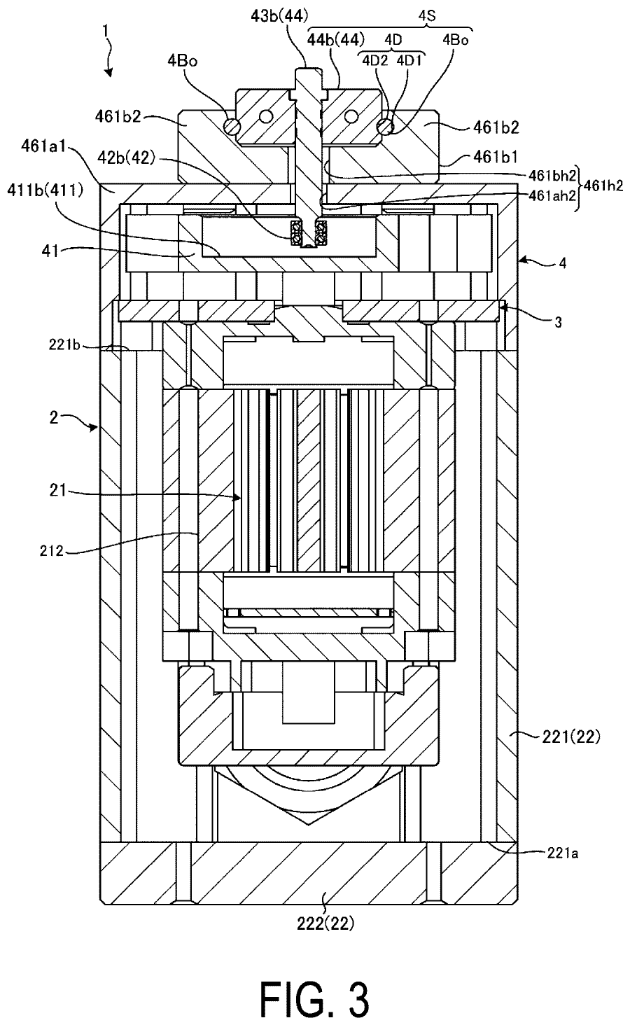

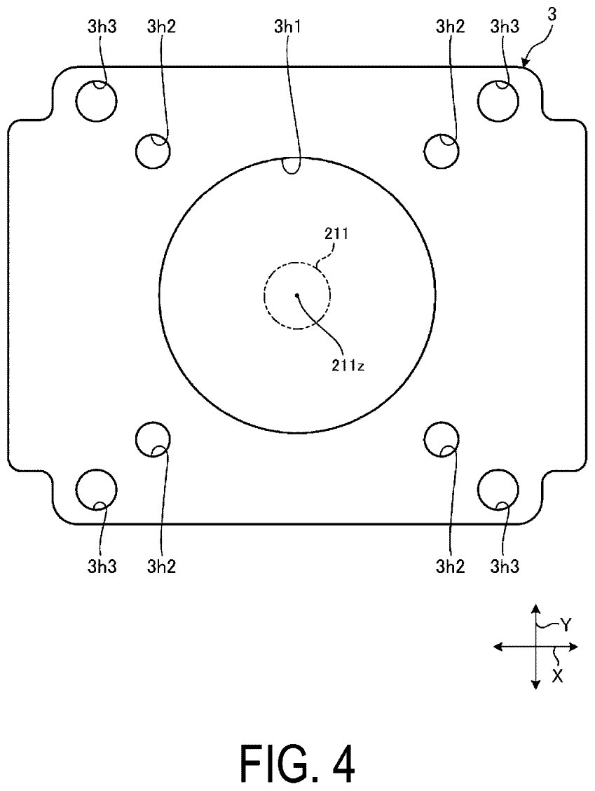

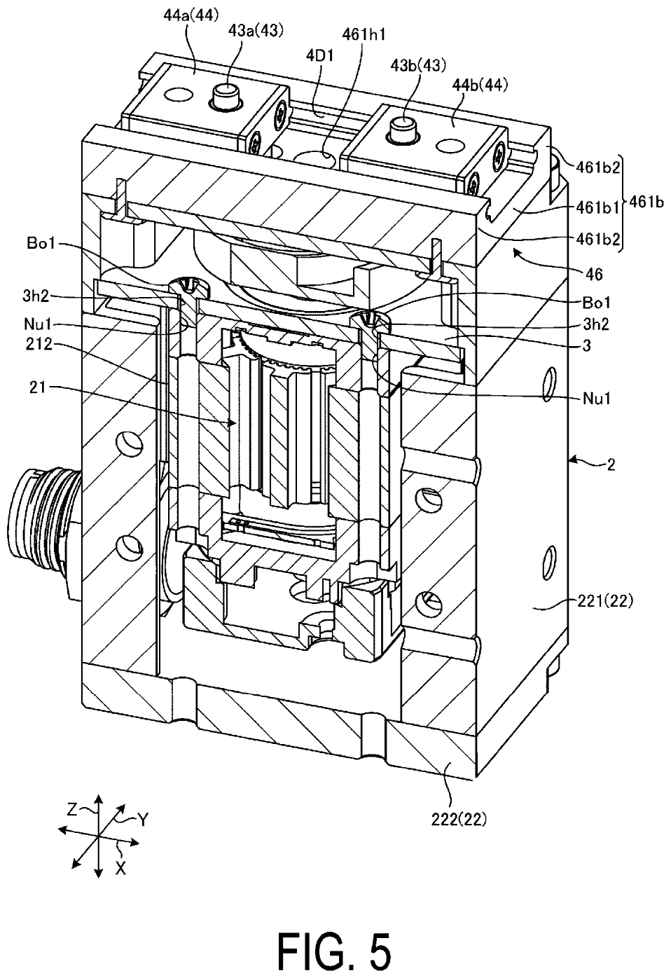

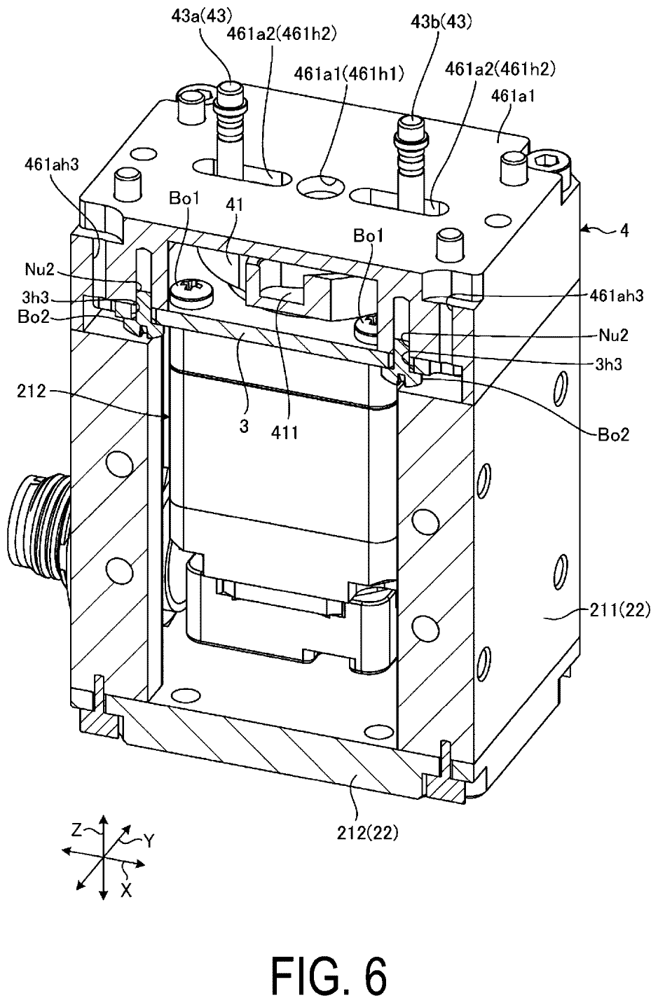

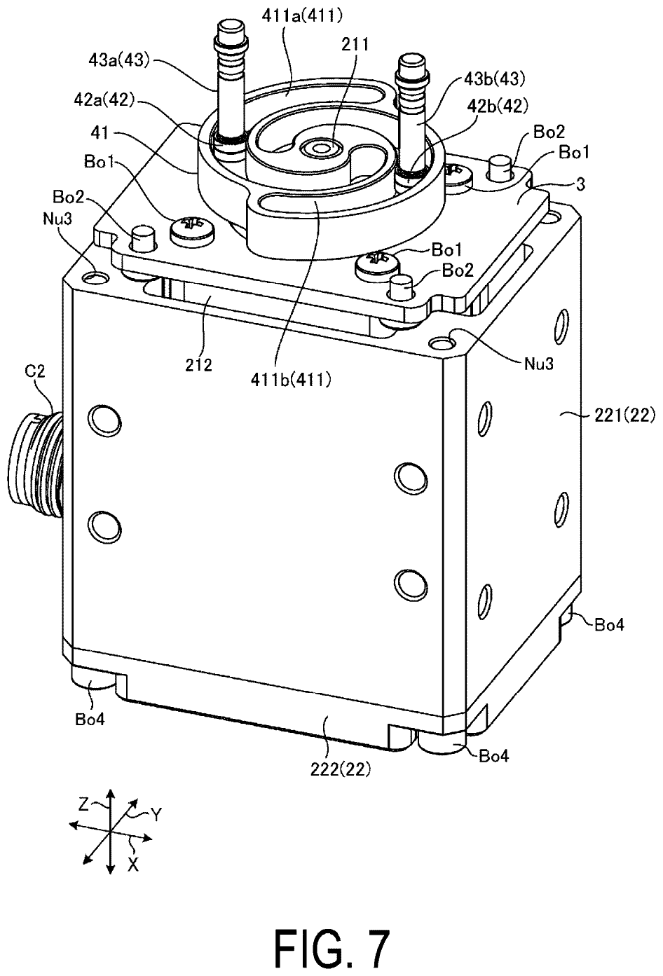

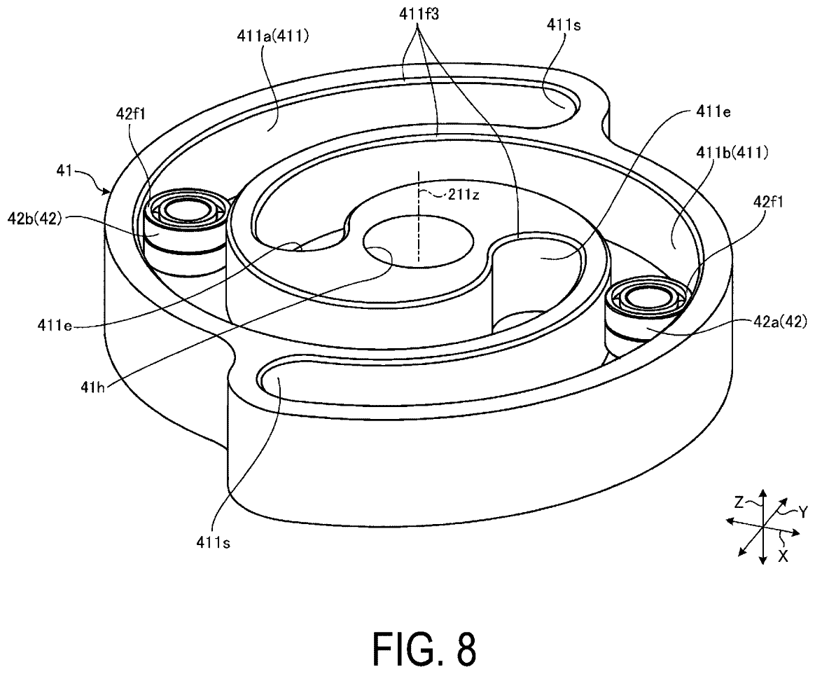

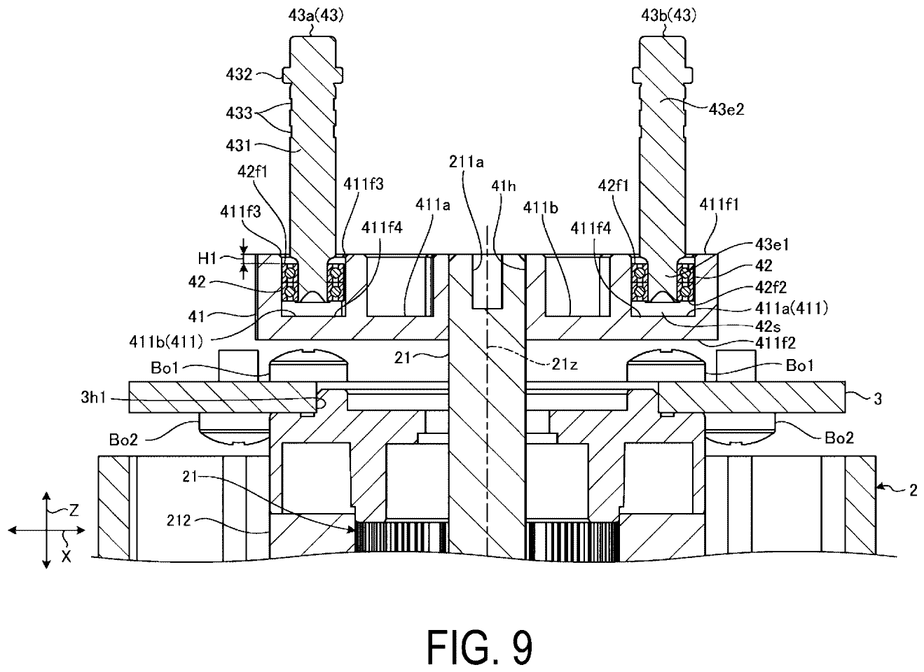

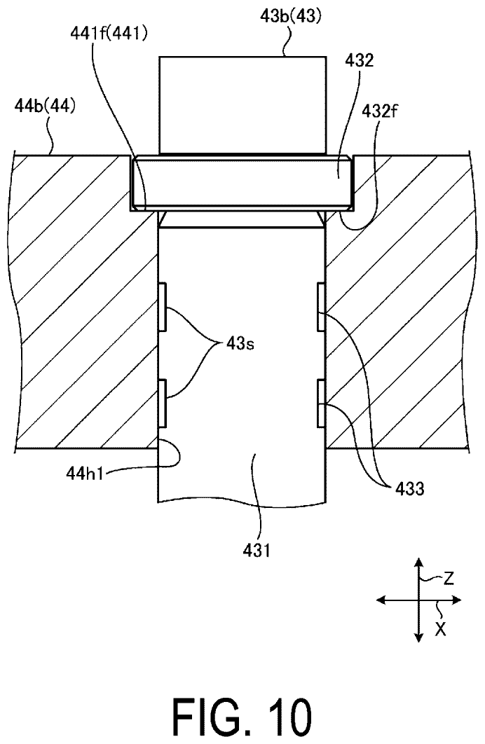

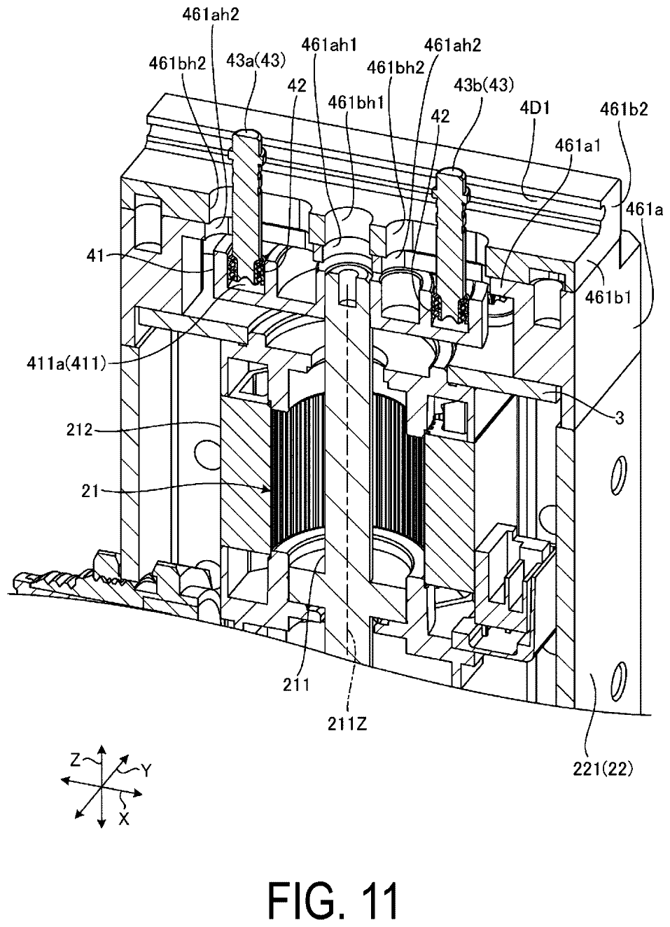

FIG. 1 is a perspective view of a grasping device 1 according to an embodiment. FIG. 2 is a cross-sectional view taken along arrow A-A in FIG. 1. FIG. 3 is a cross-sectional view taken along arrow B-B in FIG. 1. FIG. 4 is a plan view of a relay plate 3 included in the grasping device 1 according to the embodiment. FIG. 5 is a perspective view illustrating an interior of the grasping device 1 according to the embodiment. FIG. 6 is a perspective view illustrating an interior of the grasping device 1 according to the embodiment. FIG. 7 is a perspective view illustrating a cam 41 attached to a drive shaft 211 in the grasping device 1 according to the embodiment. FIG. 8 is a perspective view illustrating the cam 41 and a bearing 42 included in the grasping device 1 according to the embodiment. FIG. 9 is a cross-sectional view of the cam 41, the bearing 42, and a shaft 43 included in the grasping device 1 according to the embodiment. FIG. 10 is a diagram for explaining the shaft 43 and a block 44 included in the grasping device 1 according to the embodiment. FIG. 11 is a perspective view illustrating an interior of the grasping device 1 according to the embodiment. For ease of description in each drawing, an extending direction of a drive shaft 211 to be described later is referred to as a Z-axis direction, a direction orthogonal to the Z-axis direction is referred to as an X-axis direction, and a direction orthogonal to the Z-axis direction and the X-axis direction is referred to as a Y-axis direction.

The grasping device 1 illustrated in FIG. 1 according to the present embodiment is provided at a tip of a manipulator such as a robot arm, and is used in a robot hand or the like configured to grasp a workpiece (grasping target). As illustrated in FIGS. 2 and 3, the grasping device 1 includes a drive unit 2, the relay plate 3, and a conversion unit 4.

The drive unit 2 includes a motor 21 and a drive unit housing 22. The motor 21 is a drive source and is electrically connected to a power supply (not illustrated) via a connector C2 and an electric wire W2 illustrated in FIG. 1. The motor 21 illustrated in FIG. 2 includes the drive shaft 211 configured to be rotationally driven when electric power is supplied from the power supply. In other words, the grasping device 1 is provided with the drive unit 2 including the drive shaft 211. When the electric power is supplied from the power supply, the motor 21 rotates about a shaft center 211z of the drive shaft 211.

An engaging part 211a is formed at one end part of the drive shaft 211 in the extending direction (Z-axis direction). The engaging part 211a is a recessed part extending from one end surface toward the other end surface of the drive shaft 211 in the Z-axis direction.

The motor 21 has a motor case 212 accommodating the motor 21. The motor case 212 is formed in a rectangular parallelepiped shape by a plurality of plate members, for example, as illustrated in FIG. 6. A plurality of first screw holes Nu1 are formed at one end in the Z direction of the motor case 212 (see FIG. 5).

As illustrated in FIGS. 2 and 3, the drive unit housing 22 accommodates the motor case 212, and includes a side housing 221 and a bottom housing 222. The side housing 221 covers the periphery of the motor 21 in the X-axis direction and the Y-axis direction, is formed in a rectangular tube shape, and has a pair of openings 221a and 221b in the Z-axis direction. Of the pair of openings 221a and 221b, the opening 221a located at the other side in the Z-axis direction is closed by the bottom housing 222. Of the pair of openings 221a and 221b, the opening 221b located at one side in the Z-axis direction is closed by a cam case 461a described later. As illustrated in FIG. 7, the side housing 221 has a third screw hole Nu3 at one end part in the Z-axis direction.

The relay plate 3 is interposed between the cam case 461a described later and the motor case 212. The relay plate 3 is made of, for example, stainless steel and formed in a substantially rectangular plate shape. As illustrated in FIGS. 4 to 6, the relay plate 3 includes a drive shaft insertion hole 3h1, a first bolt insertion hole 3h2, and a second bolt insertion hole 3h3. The drive shaft 211 is inserted into the insertion hole 3h1, a first bolt Bo1 is inserted into the first bolt insertion hole 3h2, and a second bolt Bo2 is inserted into the second bolt insertion hole 3h3.

The drive shaft insertion hole 3h1, the first bolt insertion hole 3h2, and the second bolt insertion hole 3h3 pass through the relay plate 3 in the Z-axis direction. The relay plate 3 according to the present embodiment has one drive shaft insertion hole 3h1, four first bolt insertion holes 3h2, and four second bolt insertion holes 3h3.

As for the first bolt insertion hole 3h2, as will be described later, in a state where the relay plate 3 is set on the motor case 212 so that the first bolt insertion hole 3h2 and the first screw hole Nu1 coincide with each other in the X-axis direction and the Y-axis direction, when the first bolt Bo1 and the first screw hole Nu1 are screwed together, the relay plate 3 is attached to the motor case 212. That is, portions of the relay plate 3 formed with the four first bolt insertion holes 3h2 are attachment positions of the motor case 212.

As for the second bolt insertion hole 3h3, as will be described later, in a state where the cam case 461a is set on the relay plate 3 so that the second bolt insertion hole 3h3 and the second screw hole Nu2 coincide with each other in the X-axis direction and the Y-axis direction, when the second bolt Bo2 and the second screw hole Nu2 are screwed together, the relay plate 3 is attached to the cam case 461a. That is, portions of the relay plate 3 formed with the four first bolt insertion holes 3h2 are attachment positions of the cam case 461a.

As illustrated in FIG. 4, the first bolt insertion hole 3h2 is disposed to be close to the shaft center 211z of the drive shaft 211 in the radial direction. On the other hand, the second bolt insertion hole 3h3 is disposed to be further away from the shaft center 211z of the drive shaft 211 than the first bolt insertion hole 3h2 in the radial direction. In other words, in the relay plate 3 according to the present embodiment, the attachment position of the cam case 461a is different from the attachment position of the motor case 212. In the grasping device 1 according to the present embodiment, the attachment position of the cam case 461a is located at an outer side than the attachment position of the motor case 212 relative to the shaft center 211z of the drive shaft 211 passing through the relay plate 3.

As illustrated in FIG. 2, the conversion unit 4 includes the cam 41, the bearing 42, the shaft 43, the block 44, a holding part 45, and a guide part 46. The conversion unit 4 converts rotational driving of the drive shaft 211 into linear motion of the holding part 45. The conversion unit 4 according to the present embodiment may be configured by other components. The conversion unit 4 can bring a pair of holding parts 45 closer to and away from each other along the X-axis direction. A grasping target (workpiece) is grasped by bringing the pair of holding parts 45 closer to each other while the grasping target is released by bringing the pair of holding parts 45 away from each other.

As illustrated in FIG. 8, the cam 41 is formed in a disc shape having a through hole 41h, for example. As illustrated in FIG. 9, the drive shaft 211 of the motor 21 is inserted into the through hole 41h, and the cam 41 is fixed to the drive shaft 211. An iron-based sinter material, for example, is used to form the cam 41 by sintering with a metal mold. The cam 41 is formed with a cam groove 411 recessed from one end surface 411f1 toward the other end surface 411f2 in the Z-axis direction. In other words, the conversion unit 4 includes the cam 41 formed with the cam groove 411 recessed from the one end surface 411f1 toward the other end surface 411f2.

As illustrated in FIG. 8, the cam groove 411 extends in a circumferential direction relative to the shaft center 211z of the drive shaft 211. In the cam groove 411, the distance between the shaft center 211z and a center part of the cam groove 411 gradually increases toward an end part 411s at one side, while the distance between the shaft center 211z and the center part of the cam groove 411 gradually decreases toward an end part 411 at the other side. The cam 41 according to the present embodiment includes a pair of cam grooves 411a and 411b.

An opening side of the cam groove 411 being the one end surface 411f1 side of the cam 41 is chamfered. Then, an inclined surface 411f3 (see FIG. 9) having a length of 0.1 to 0.2 mm in the Z-axis direction, for example, is formed on the cam groove 411 by the chamfer. The inclined surfaces 411f3 are provided on both side walls of the cam groove 411 to face each other in the extending direction of the cam groove 411. Such inclined surface 411f3 facilitates the insertion of the bearing 42 into the cam groove 411 during assembly of the grasping device 1, thereby improving workability.

As illustrated in FIG. 9, the bearings 42 are respectively inserted into the pair of cam grooves 411. That is, the conversion unit 4 includes the bearings 42 inserted into the cam groove 411. The bearing 42 functions as a cam follower with respect to the cam 41. A lubricant is applied to an inner wall surface of the cam groove 411. Although the grasping device 1 including the two bearings 42 is described in the present embodiment, the number of bearings 42 can be appropriately changed.

The other end part of the shaft 43 is inserted into the bearing 42. More specifically, the other end part of the shaft 43 is an end part on the lower side in the Z-axis direction, and the other end part of the shaft 43 is press-fitted into the bearing 42 according to the present embodiment. An end surface 42f1 of the bearing 42 is disposed apart from the one end surface 411f1 on the other end surface 411f2 side in the Z-axis direction (the extending direction of the drive shaft 211). To be more specific, the bearing 42 is disposed inside the cam groove 411 so that t the end surface 42f1 of the bearing 42 and the one end surface 411f1 of the cam 41 are displaced from each other in the Z-axis direction. In the Z-axis direction, a difference H1 between the one end surface 411f1 of the cam 41 and the end surface 42f1 of the bearing 42 is, for example, 0.5 mm. Thus, in the grasping device 1 according to the present embodiment, as illustrated in FIG. 8, the end surface 42f1 of the bearing 42 is located further below the lower end part of the chamfered inclined surface 411f3 in the Z-axis direction. The position of the bearing 42 in the Z-axis direction is determined by a widened part 432 and a recessed part 441 described later, and as illustrated in FIG. 9, a clearance 42s is formed between a bottom surface 411f4 of the cam groove 411 and a bottom surface 42f2 of the bearing 42.

The shaft 43 is formed to extend in the Z-axis direction. One end part 43el of the shaft 43 in the Z-axis direction is inserted into the bearing 42. On the other hand, the other end part 43e2 of the shaft 43 in the Z-axis direction is inserted into the block 44 (see FIG. 2). The shaft 43 according to the present embodiment includes a shaft main body part 431, the widened part 432 formed at the other end part of the shaft main body part 431 and protruding outward in the radial direction from a circumferential surface of the shaft main body part 431, and a bonding groove 433 recessed inward in the radial direction from the circumferential surface of the shaft main body part 431.

For example, the bonding groove 433 is formed to continuously make one round in the circumferential direction of the shaft main body part 431. As illustrated in FIG. 10, the shaft 43 of the present embodiment includes two bonding grooves 433, for example, spaced apart in the Z-axis direction. In the radial direction of the shaft 43, a clearance 43s larger than a clearance formed between the shaft main body part 431 and a first through hole 44h1 is formed between the bonding groove 433 and the first through hole 44h1. The widened part 432 has a lower end surface 432f orthogonal to the extending direction of the drive shaft 211. The grasping device 1 according to the present embodiment includes a pair of shafts 43a and 43b.

The block 44 is formed in a substantially rectangular parallelepiped shape as illustrated in FIG. 1, and is formed with two through holes 44h1 and 44h2 passing through the block 44 in the Z-axis direction as illustrated in FIG. 2. The other end part in the Z-axis direction of the shaft 43 is inserted into the first through hole 44h1 of the two through holes 44h1 and 44h2. After an adhesive is applied to the bonding grooves 433 of the shaft main body part 431, the shaft 43 is inserted into the first through hole 44h1 of the block 44, and then the adhesive is solidified in the clearances 43s, whereby the other end part of the shaft 43 is fixed to the block 44. As illustrated in FIG. 10, since the shaft 43 is inserted into the block 44 while the outer peripheral surface of the shaft main body part 431 and the inner peripheral surface of the first through hole 44h1 being close to each other, the shaft 43 can be disposed along the Z-axis direction with respect to the block 44. Further, a shaft part of the holding part 45 is inserted into the second through hole 44h2 of the two through holes 44h1 and 44h2, whereby the holding part 45 is fixed to the block 44.

In the block 44, the recessed part 441 to be fitted with the widened part 432 of the shaft 43 is formed at a portion where the first through hole 44h1 is formed. The recessed part 441 has an upper end surface 441f orthogonal to the Z-axis direction. When the widened part 432 is fitted into the recessed part 441, the shaft 43 is positioned in the Z-axis direction with respect to the block 44, whereby the bearing 42 can be positioned in the Z-axis direction with respect to the block 44. The grasping device 1 according to the present embodiment includes a pair of blocks 44a and 44b.

The holding parts 45 are provided in pairs in the block 44 according to the present embodiment. To be more specific, the holding parts 45 include the shaft part inserted into the second through hole 44h2 of the block 44, and a claw part (not illustrated) configured to move closer to and away from a grasping target (hereinafter, simply referred to as “move closer to and away from”) in the X-axis direction. The holding parts 45 can pinch the grasping target (workpiece) by moving a pair of claw parts closer to and away from each other in the X-axis direction.

The guide part 46 guides the pair of blocks 44 to move along the X-axis direction. As illustrated in FIG. 1, the guide part 46 includes a base part 461 constituted by part of the cam case 461a and part of a guide rail 461b to be described later. Part of the cam case 461a constituting the base part 461 is a case top plate 461al described later, and part of the guide rail 461b constituting the base part 461 is a coupling part 461b1 described later. As illustrated in FIG. 2, the base part 461 has an inspection hole (through hole) 461h1 passing through the base part 461 in the Z-axis direction, and a pair of guide holes 461h2 across the inspection hole 461h1 in the X-axis direction.

The inspection hole 461h1 has substantially the same diameter as the drive shaft 211 and is formed in, for example, a cylindrical shape. The engaging part 211a of the drive shaft 211 can be visually recognized from above in the Z-axis direction (from one side in the extending direction). That is, the conversion unit 4 includes the base part 461 formed with the inspection hole (through hole) 461h1. Through this inspection hole, the engaging part 211a of the drive shaft 211 can be visually recognized from above in the Z-axis direction (from one side in the extending direction). In the grasping device 1, the center of the inspection hole 461h1 and the shaft center 211z of the drive shaft 211 match each other in the Z-axis direction.

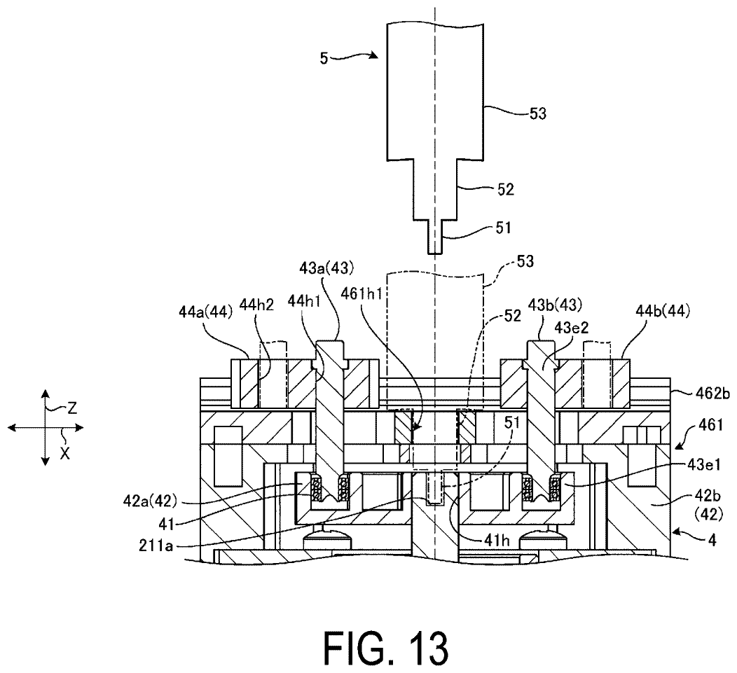

A jig 5 is inserted into the inspection hole 461h1 during the assembly of the grasping device 1 as described later. The jig 5 is a so-called stepped shaft including an engagement target part 51, an inspection hole facing part 52, and a grip part 53, and is formed to extend along the Z-axis direction, as illustrated in FIG. 13.

The engagement target part 51 can be engaged with the engaging part 211a formed on the drive shaft 211, and is formed at the tip of the jig 5 in the Z-axis direction. The engagement target part 51 according to the present embodiment is formed in a columnar shape, for example.

The inspection hole facing part 52 is formed adjacent to the engagement target part 51 in the Z-axis direction. As for the inspection hole facing part 52, in a state where the engagement target part 51 is engaged with the engaging part 211a, the outer peripheral surface of the inspection hole facing part 52 faces the inner peripheral surface of the inspection hole 461h1. The inspection hole facing part 52 according to the present embodiment is formed in, for example, a columnar shape with the length in the radial direction longer than the length in the radial direction of the engagement target part 51.

The grip part 53 is a portion gripped by an operator when inserting the tip part of the jig 5 into the inspection hole 461h1. The grip part 53 is formed adjacent to the inspection hole facing part 52 in the Z-axis direction. The grip part 53 according to the present embodiment is formed in, for example, a columnar shape with the length in the radial direction longer than the length in the radial direction of the inspection hole facing part 52.

As illustrated in FIG. 2, the guide hole 461h2 passes through the base part 461 in the Z-axis direction. Furthermore, the guide hole 461h2 extends along the X-axis direction. The shafts 43 are respectively inserted into the guide holes 461h2. The guide hole 461h2 allows the shaft 43 to move linearly along the X-axis direction, but restricts the shaft 43 from moving in the Y-axis direction.

As illustrated in FIG. 1, the guide part 46 includes the cam case 461a. The cam case 461a accommodates the cam 41. To be more specific, the cam case 461a is formed in a box shape covering one side of the cam 41 in the Z-axis direction and both sides of the cam 41 in the X-axis direction and the Y-axis direction and having an opening at the other side in the Z-axis direction. The cam case 461a includes the case top plate 461al formed in a rectangular plate shape.

The case top plate 461al has a top plate inspection hole 461ah1 constituting the inspection hole 461h1 described above and a top plate guide hole 461ah2 constituting the guide hole 461h2 described above.

The cam case 461a has a third bolt insertion hole 461ah3 passing through the cam case 461a in the Z-axis direction (see FIG. 6).

As illustrated in FIG. 3, the guide part 46 includes a linear guide 4s constituted of the block 44, the guide rail 461b, a steel ball 4Bo, and a steel ball accommodation groove 4D. The linear guide 4s facilitates the movement of the block 44 relative to the guide rail 461b.

The guide rail 461b includes the coupling part 461b1 formed in a rectangular plate shape and a pair of rail parts 461b2 facing each other in the Y-axis direction. The coupling part 461b1 couples the pair of rail parts 461b2. The coupling part 461b1 has a coupling part inspection hole 461bh1 constituting the inspection hole 461h1 described above and a coupling part guide hole 461bh2 constituting the guide hole 461h2 described above.

The steel ball accommodation groove 4D accommodates the steel ball 4Bo and extends along the X-axis direction. The steel ball accommodation groove 4D is constituted of a first groove 4D1 formed on a surface of the rail part 461b2 facing the block 44, and a second groove 4D2 formed on a surface of the rail part 461b2 facing the block 44.

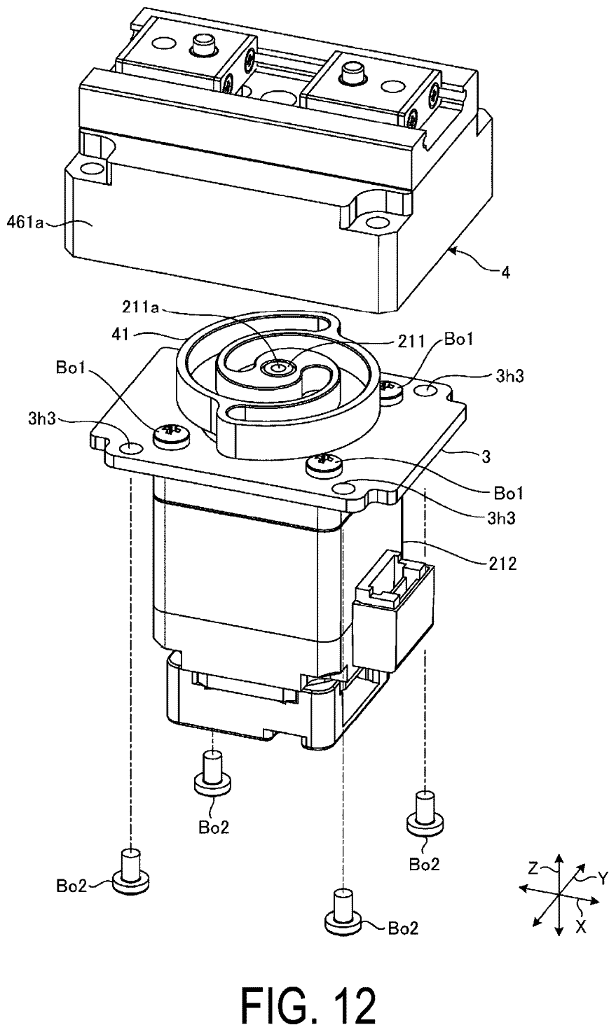

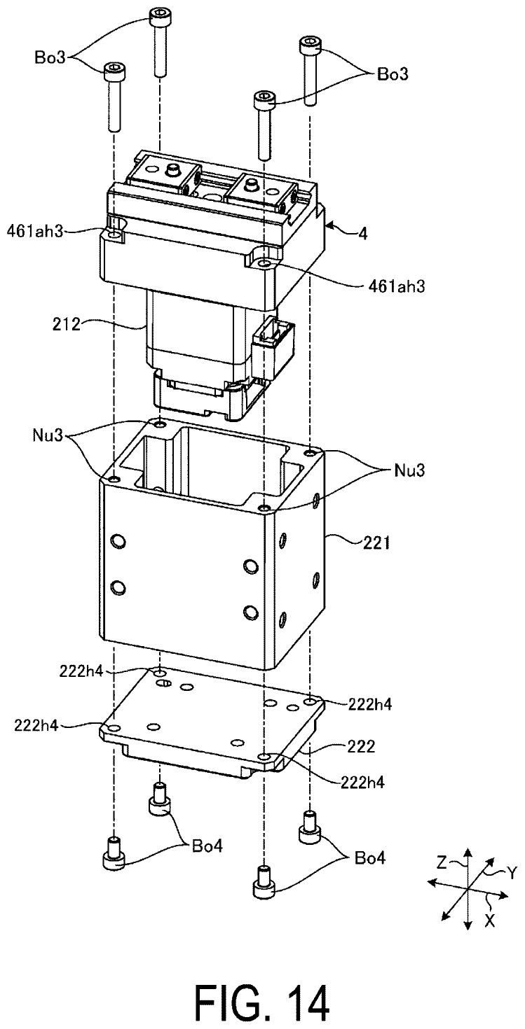

Next, the assembly of the grasping device 1 having the above-described configuration will be described with reference to FIGS. 12 to 14. FIG. 12 is a perspective view for explaining attachment of the conversion unit 4 to the motor case 212 in the grasping device 1 according to the embodiment. FIG. 13 is a side view illustrating the jig 5 used for assembling the grasping device 1 according to the embodiment. FIG. 14 is a perspective view for explaining the attachment of the drive unit housing 22 to the conversion unit 4 in the grasping device 1 according to the embodiment.

First, the operator sets the relay plate 3 on one side in the Z-axis direction of the motor case 212 in a state where the first bolt insertion hole 3h2 (see FIG. 5) of the relay plate 3 and the first screw hole Nu1 (see FIG. 5) of the drive unit 2 are aligned with each other.

Subsequently, the operator inserts the tip of the first bolt Bo1 into the first bolt insertion hole 3h2, and then screws the first bolt Bo1 into the first screw hole Nu1, thereby fixing the relay plate 3 to the motor case 212 as illustrated in FIG. 12. Then, the operator fixes the cam 41 to the tip of the drive shaft 211.

Subsequently, the operator sets the conversion unit 4 on one side in the Z-axis direction of the relay plate 3. In this state, the tip part of the jig 5 is inserted into the inspection hole 461h1. Then, as indicated by a virtual line in FIG. 13, the operator engages the engagement target part 51 of the jig 5 with the engaging part 211a of the drive shaft 211 and causes the outer peripheral surface of the inspection hole facing part 52 of the jig 5 to face the inner peripheral surface of the inspection hole 461h1, thereby positioning the conversion unit 4 with respect to the motor case 212.

In this state, the operator aligns the second bolt insertion hole 3h3 (see FIG. 6) of the relay plate 3 with the second screw hole Nu2 (see FIG. 6) of the conversion unit 4. Subsequently, the operator inserts the tip of the second bolt Bo2 into the second bolt insertion hole 3h3, and then screws the second bolt Bo2 into the second screw hole Nu2, thereby fixing the relay plate 3 to the conversion unit 4. As a result, the conversion unit 4 is attached to the motor case 212 with the relay plate 3 interposed between the conversion unit 4 and the motor case 212.

Subsequently, as illustrated in FIG. 14, the operator sets the conversion unit 4 on one side in the Z-axis direction of the side housing 221 in a state where the third bolt insertion hole 461ah3 of the conversion unit 4 and the third screw hole Nu3 of the side housing 221 are aligned with each other.

Subsequently, the operator inserts the tip of a third bolt Bo3 into the third bolt insertion hole 461ah3, and then screws the third bolt Bo3 into the third screw hole Nu3, thereby fixing the side housing 221 to the motor case 212 and the conversion unit 4.

Subsequently, the operator sets the side housing 221 on one side in the Z-axis direction of the bottom housing 222 in a state where a fourth bolt insertion hole 222h4 of the bottom housing 222 and a fourth screw hole (not illustrated) of the side housing 221 are aligned with each other.

Subsequently, the operator inserts the tip of a fourth bolt Bo4 into the fourth bolt insertion hole 222h4, and then screws the fourth bolt Bo4 into the fourth screw hole (not illustrated) of the side housing 221 so as to fix the bottom housing 222 to the side housing 221, thereby assembling the grasping device 1.

Next, a description will be given of a case where a grasping target is grasped in the grasping device 1 having the above-described configuration. In the initial state of the grasping device 1, as illustrated in FIG. 1, the pair of blocks 44 are disposed at the furthest positions in the X-axis direction, and the bearing 42 is disposed at the end part 411s at the one side of the pair of cam grooves 411.

The motor 21 is driven from this initial state, and the drive shaft 211 is rotationally driven about the shaft center 211z by the driving of the motor 21. When the drive shaft 211 is rotationally driven, the cam 41 fixed to the drive shaft 211 is rotationally driven about the shaft center 211z.

When the cam 41 is rotationally driven, the bearing 42 moves from the end part 411s at the one side toward the end part 411e at the other side along the extending direction of the cam groove 411.

At this time, one end part of the shaft 43 is press-fitted into the bearing 42, and the movement of the shaft 43 in the X-axis direction is allowed by the guide hole 461h2 while the movement of the shaft 43 in the Y-axis direction is restricted. Therefore, the pair of blocks 44 move closer to each other in the X-axis direction. Then, along with the movement of the pair of blocks 44, the pair of holding parts 45 also move closer to each other in the X-axis direction, and grasps the grasping target disposed between the pair of holding parts 45. In the above-discussed grasping device 1, when the grasping target is released, the pair of blocks 44 move away from each other in the X-axis direction and the pair of holding parts 45 move away from each other in the X-axis direction by reversely driving the motor 21.

As described above, the grasping device 1 according to the present embodiment has the following configuration. The end surface 42f1 of the bearing 42 is disposed apart from the one end surface 411f1 on the other end surface 411f2 side in the extending direction of the drive shaft 211. However, before the assembly of the grasping device 1, for example, during the transportation of components, the cams 41 may come into contact with each other or another component may come into contact with the cams 41, and thus a small scratch may be formed on the one end surface 411f1 of the cam 41 formed with the cam groove 411. However, with the above-described configuration, the grasping device 1 according to the present embodiment can suppress the formation of a scratch on the inner peripheral surface of the cam groove 411 in contact with the bearing 42. As a result, with the grasping device 1 according to the present embodiment, since it is possible to suppress the bearing 42 coming into contact with a scratch on the inner peripheral surface of the cam groove 411, the bearing 42 can be smoothly moved along the cam groove 411.

The grasping device 1 according to the present embodiment has the following configuration. The shaft 43 includes the widened part 432 protruding outward in the radial direction, and the block 44 is formed with the recessed part 441 to be engaged with the widened part 432. Therefore, the grasping device 1 according to the present embodiment positions the shaft 43 in the Z-axis direction with respect to the block 44 with the widened part 432 and the recessed part 441, thereby positioning the bearing 42 in the Z-axis direction with respect to the block 44. That is, the grasping device 1 according to the present embodiment can easily position the bearing 42 with respect to the block 44 with the widened part 432 and the recessed part 441.

The grasping device 1 according to the present embodiment has the following configuration. The drive shaft 211 is formed with the engaging part 211a at one end part in the extending direction, and the conversion unit 4 includes the base part 461 formed with the inspection hole (through hole) 461h1. Through this inspection hole, the engaging part 211a of the drive shaft 211 can be visually recognized from one side in the extending direction. Therefore, when assembling the grasping device 1 according to the present embodiment, the operator can visually recognize the inspection hole 461h1 from above in the Z-axis direction and visually recognize the engaging part 211a through the inspection hole 461h1. As a result, the grasping device 1 according to the present embodiment can easily dispose the conversion unit 4 at a proper position with respect to the drive unit 2 in the directions orthogonal to the shaft center 211z (that is, in the X-axis direction and the Y-axis direction).

The grasping device 1 according to the present embodiment has the following configuration. The shaft 43 includes the shaft main body part 431 and the bonding grooves 433 formed on the shaft main body part 431 and recessed inward in the radial direction. The shaft 43 is fixed to the block 44 with an adhesive filling the bonding grooves 433. Therefore, the operation of fixing the shaft 43 to the block 44 can be easily carried out.

The grasping device 1 according to the present embodiment has the following configuration. The grasping device 1 further includes the relay plate 3 interposed between the cam case 461a and the motor case 212. In the relay plate 3, an attachment position of the cam case 461a is different from an attachment position of the motor case 212. Therefore, the grasping device 1 according to the present embodiment can easily carry out the operation of attaching the cam case 461a to the motor case 212 by the relay plate 3.

In the above-discussed embodiment, the grasping device 1 including two holding parts 45 has been described. However, the grasping device 1 according to the present invention is not limited to the above-discussed device. For example, the grasping device 1 may include three holding parts 45 or may include four or more holding parts 45. Further, the guide part 46 according to the above-discussed embodiment has been described as being constituted of the cam case 461a and the guide rail 461b. However, the guide part 46 according to the present invention is not limited to the above-discussed guide part. For example, the guide part 46 may be integrally constituted of the cam case 461a and the guide rail 461b.

Further, the present invention is not limited by the above-described embodiments. A configuration obtained by appropriately combining the constituent elements of the above-described embodiment is also included in the present invention. Furthermore, further effects and modifications can be easily derived by a person skilled in the art. Thus, a wide range of aspects of the present invention is not limited to the embodiments described above and may be modified variously.

Reference Signs List

1 Grasping device, 2 Drive unit, 211 Drive shaft, 211a Engaging part, 212 Motor case, 3
Relay plate, 4 Conversion unit, 41 Cam, 411 Cam groove, 411f1 One end surface, 411f2
Other end surface, 42 Bearing, 42f1 End surface (of bearing), 43 Shaft, 431 Shaft main body
part, 432 Widened part, 433 Bonding groove, 44 Block, 441 Recessed part, 45 Holding part,
461 Base part, 461a Cam case, 461h1 Inspection hole (through hole)

1. A grasping device, comprising
a conversion unit configured to convert rotational driving of a drive shaft into linear motion of a holding part, wherein
the conversion unit includes
a cam formed with a cam groove recessed from one end surface toward the other end surface, and
a bearing inserted into the cam groove, and
an end surface of the bearing is disposed apart from the one end surface on the other end surface side in an extending direction of the drive shaft.

2. The grasping device according to claim 1, wherein
the conversion unit further includes a shaft and a block,
another end part of the shaft is inserted into the bearing,
one end part of the shaft is inserted into the block,
the shaft includes a widened part protruding outward in a radial direction, and
the block is formed with a recessed part to be engaged with the widened part.

3. The grasping device according to claim 1- or 2, wherein
the drive shaft is formed with an engaging part at one end part in the extending direction,
the conversion unit includes a base part formed with a through hole, and the engaging part of the drive shaft is visually recognizable through the through hole from one side in the extending direction.

4. The grasping device according to claim 2, wherein
the shaft includes a shaft main body part and a bonding groove recessed inward in the radial direction on a circumferential surface of the shaft main body part, and
the shaft is fixed to the block with an adhesive filled into the bonding groove.

5. The grasping device according to claim 1, further comprising:
a cam case configured to accommodate the cam;
a motor case configured to accommodate a motor provided with the drive shaft; and
a relay plate interposed between the cam case and the motor case,
wherein in the relay plate, an attachment position of the cam case is different from an attachment position of the motor case.
